(19) United States
(12) Patent Application Publication
(10) Pub. No.: US 2014/0144278 A1
(43) Pub. Date: May 29, 2014

(54) RELEASE MECHANISM

(71) Applicant: Mark G. Tomandl, Cedar Springs, MI (US)

(72) Inventor: Mark G. Tomandl, Cedar Springs, MI (US)

(21) Appl. No.: 13/315,797

(22) Filed: Dec. 9, 2011

(51) Int. Cl. F16C 1/12

(52) U.S. Cl. 74/502.2

(57) ABSTRACT

A release mechanism generates a force on a cable to operate an adjustment mechanism or the like in a seat or other device. The release mechanism includes a rotor, a housing, a spring, and a cover that attaches to the housing. The spring generates a torque permitting the rotor to form a temporary subassembly with the housing prior to final assembly. The spring also axially biases the rotor into engagement with the cover to prevent rattling.

### BACKGROUND OF THE INVENTION

Seats for motor vehicles and the like may include one or more adjustment features such as a seat back tilt mechanism that selectively retains the seat back in a position selected by a user. The seat may include additional adjustment features such as fore-aft sliding of the seat relative to the vehicle floor, and other such adjustment features. Various types of mechanisms have been developed to retain the seat components in a desired position. Such mechanisms may be actuated by a cable that is connected to a manually-operated release mechanism by an elongated cable. Also, elongated cables may be utilized to operably interconnect a lever or other release member located inside a vehicle to a component such as a hood release latch. Various mechanisms for manual user input have been developed. However, known mechanisms may suffer from various drawbacks.

### BRIEF SUMMARY OF THE INVENTION

One aspect of the present invention is a release mechanism of the type utilized to shift an elongated connector to selectively release an adjustment mechanism. The release mechanism includes a housing defining a pivot element, and a rotor disposed within the housing and pivotably engaging the pivot element for rotation about an axis. The rotor is adapted to be manually rotated by a user, and the rotor includes a connecting feature that provides for connecting an end of an elongated flexible cable to the rotor, such that rotation of the rotor shifts the elongated flexible cable. The release mechanism also includes a helical coil spring having a first end connected to the housing, and a second end connected to the rotor. The coil spring is rotationally deformed to rotationally bias the rotor for rotation in a first direction about the axis, and the coil spring is also compressed, and biases the rotor axially away from the housing along the axis.

The housing may include a separate cover that snaps onto a main portion of the housing during assembly. The housing and rotor can be utilized in either a “left hand” or “right hand” orientation. The housing and rotor may be symmetrical about a center plane, and the direction of the rotational bias of the rotor can be changed by selecting a helical coil that generates either a clockwise or counter clockwise torque on the rotor. Also, the housing may include connecting features whereby a cable can be interconnected to the housing of the release mechanism at either of two opposite side faces of the housing.

The release mechanism may include a rotation-limiting feature such as a boss on the rotor and corresponding arcuate slot on the housing to limit rotation of the rotor relative to the housing. During assembly, the rotor is rotated against the spring bias relative to the main portion of the housing, and the rotor is shifted axially to move the boss into the arcuate slot. Friction between the boss and a side surface of the arcuate slot to prevent shifting of the rotor that could otherwise occur due to the axial bias of the helical coil spring.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a partially fragmentary side elevational view of a motor vehicle seat or the like including an adjustment mechanism and a release mechanism that is interconnected to the adjustment mechanism by an elongated cable;

FIG. 2 is a top plan view of a release mechanism according to one aspect of the present invention;

FIG. 3 is a front elevational view of the release mechanism of FIG. 2;

FIG. 4 is an exploded isometric view of the release mechanism of FIG. 2;

FIG. 5 is a partially exploded isometric view of the release mechanism of FIG. 2;

FIG. 6 is a partially fragmentary enlarged, isometric view of a portion of a release mechanism according to one aspect of the present invention;

FIG. 7 is a partially fragmentary, enlarged isometric view of a portion of a rotor of a release mechanism according to one aspect of the present invention.

### DETAILED DESCRIPTION OF EMBODIMENTS

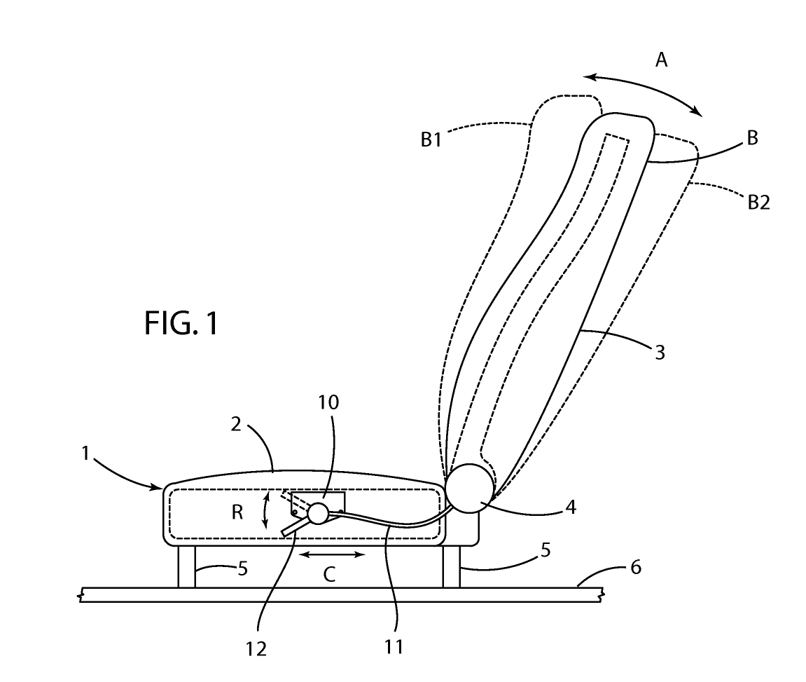

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a seat assembly 1 includes a seat portion 2 and a back portion 3 that is pivotally interconnected to the seat portion for fore-aft tilting movement as indicated by the arrow “A.” A releasable adjustment mechanism 4 selectively retains the back portion 3 at various positions B, B1, B2 etc. An adjustment mechanism 4 may be positioned on both the left and right sides of the seat 1. A support structure 5 interconnects the seat assembly 1 with a vehicle floor 6. The support structure 5 may include slides or the like (not shown) that permit movement of the seat assembly 1 in a fore-aft direction relative to the floor 6 of a vehicle as indicated by the arrow “C.” The seat portion 2, back portion 3, adjustment mechanism 4, and support structure 5 may comprise conventional, known components such that these parts will not be described in detail herein

A release mechanism 10 is operably interconnected to the adjustment mechanism 4 by an elongated cable 11. The release mechanism 10 includes a movable input member such as a handle 12 that is movable as indicated by the arrow “R” by a user to selectively release adjustment mechanism 4 to permit tilting of the seat back 3.

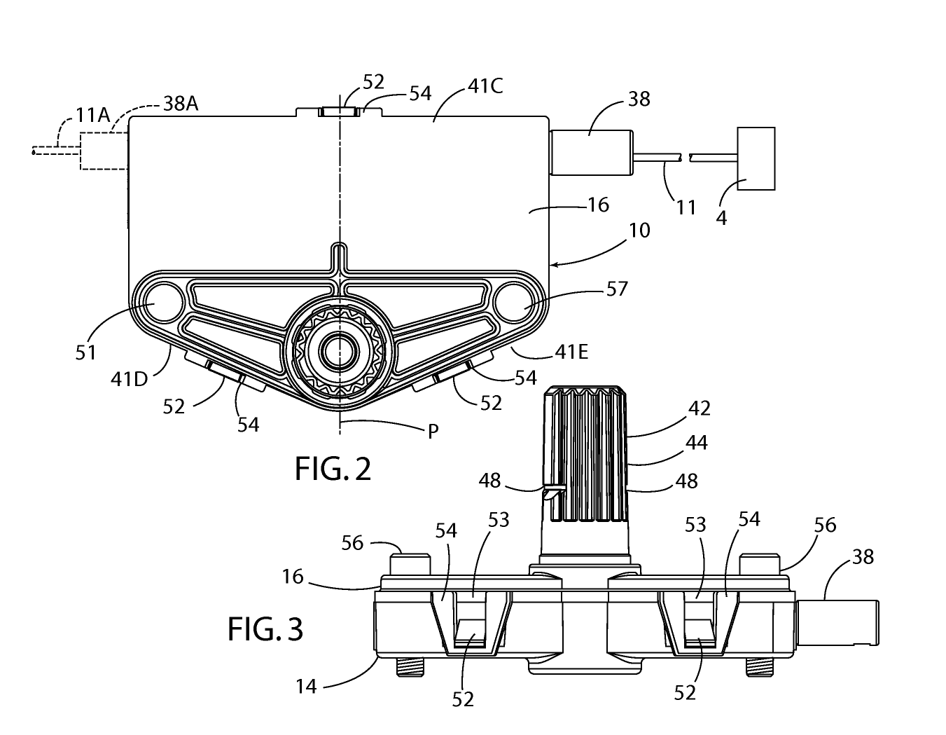

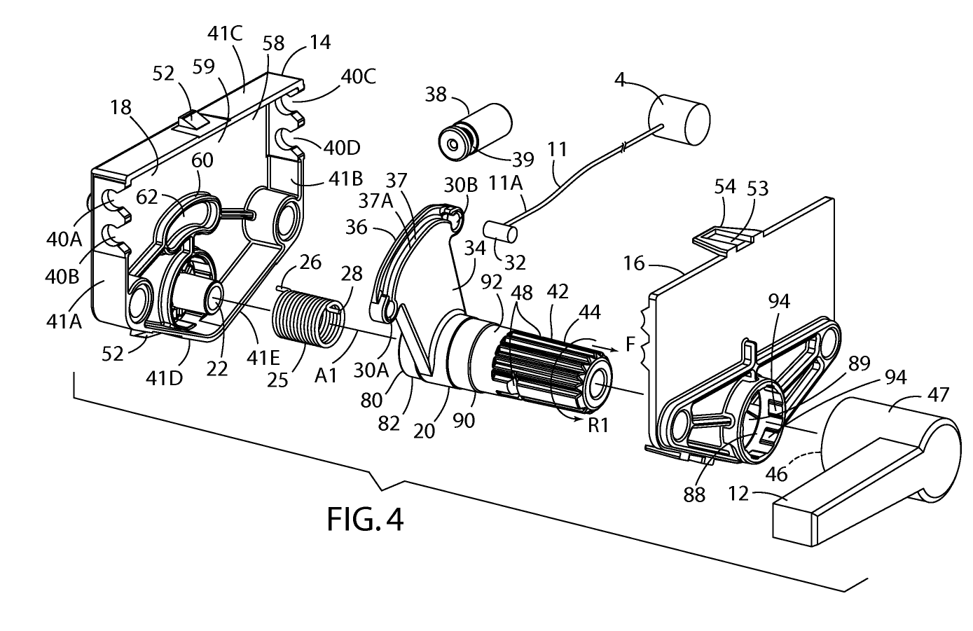

With further reference to FIGS. 2-4, mechanism 10 includes a housing 14 and a cover 16 that together form an interior space 18. When assembled, a rotor 20 is rotatably interconnected with a boss or protrusion 22 of housing 14 for rotation about an axis “A1” (FIG. 4). As discussed in more detail below, a spring 25 includes a first end 26 that is interconnected to housing 14, and a second end 28 that is interconnected with rotor 20 to rotationally bias the rotor 20 relative to housing 14 for rotation about an axis “A1.”Rotor 20 includes an arm 34 having an end portion 36 that includes first and second connecting features 30A and 30B (cavities) that interconnect with a fitting 32 of cable 11 whereby rotation of rotor 20 longitudinally shifts the cable 11 and releases adjustment mechanism 4. The arm 34 is substantially symmetrical such that either connecting feature 30A or connecting feature 30B can be utilized to connect with a cable end fitting 32. In the illustrated example, the end fitting 32 is received in connector 30A to thereby pull on cable 11 upon rotation of rotor 20 in the direction of the arrow “R1.” An end portion 11A of cable 11 wraps around curved end surface 37 of arm 34. End surface 37 may include a relatively flat central portion 37A having a reduced radius about axis A1 to provide increased force on cable 11 as it wraps around central portion 37A. Cable end fitting 32 may be received in connecting feature 30B such that rotation of rotor 20 in a direction opposite the arrow “R1” pulls on cable 11 to actuate adjustment mechanism 4. The direction of rotational bias provided by spring 25 may be reversed if connecting feature 30B is utilized to thereby provide the proper rotational bias for a particular application. A bushing or fitting 38 includes an annular groove 39 that engages a selected one of the openings 40A-40D of sidewall 41A or 41B of housing 14 to slidably support cable 11 where it enters housing 14.

Rotor 20 includes a generally cylindrical extension 42 having a plurality of teeth or splines 44 that engage corresponding teeth or splines 46 on an interior portion of extension 47 of handle 12 in a known manner to interconnect rotor 20 and handle 12. A pair of transverse slots 48 receive a clip or other retainer (not shown) to retain handle 12 to rotor 20 in a conventional manner.

Housing 14 includes a plurality of wedges 52 that protrude from sidewalls 41C, 41D, and 41E. Wedges 52 are received in openings 53 formed in transverse flaps or extensions 54 (see also FIGS. 2 and 3). The wedges 52 and corresponding connectors 53-54 retain cover 16 on housing 14 prior to installation of the release mechanism 10 on a seat assembly 1. Threaded fasteners 56 (FIG. 3) are received in openings 57 in housing 14 and cover 16 (FIGS. 2 and 3) and engage threaded openings in the seat structure to secure the release mechanism 10 to the seat assembly 1. Fasteners 56 also ensure that housing 14 and cover 16 remain assembled together when mechanism 10 is attached to the seat assembly 1.

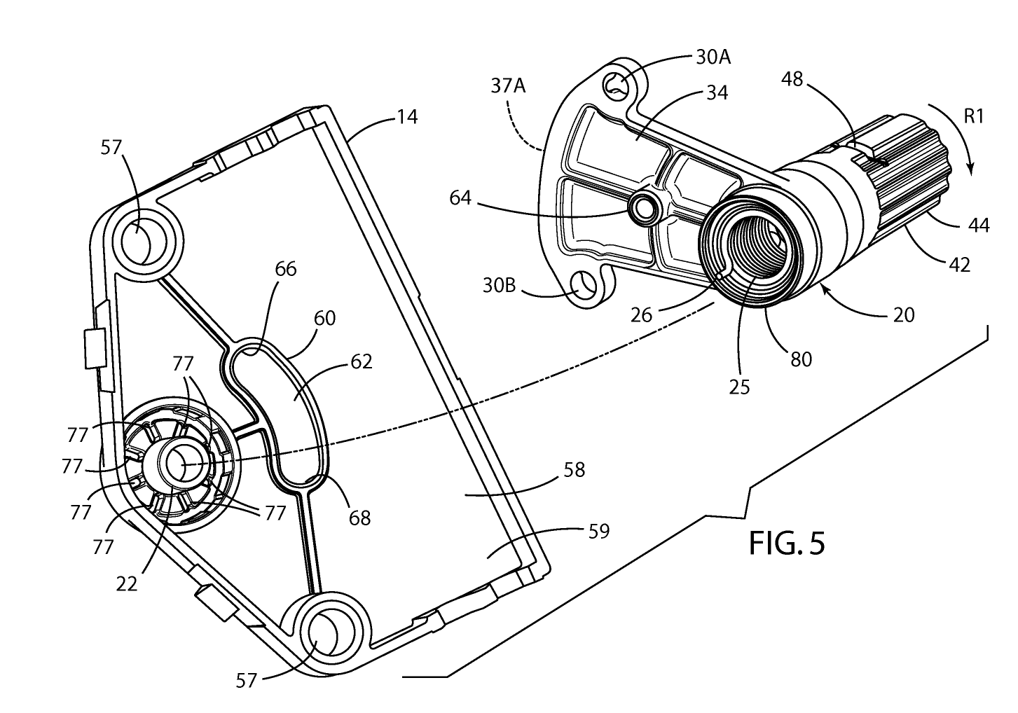

With further reference to FIG. 5, arm 34 of rotor 20 includes cylindrical extension 64. Housing 14 includes a ridge or sidewall 60 that protrudes from inner surface 58 of sidewall 59 of housing 14. When assembled, extension 64 is received in arcuate slot 62, and spring 25 rotatably biases extension 64 towards end surface 66 or end surface 68 of arcuate slot 62. Spring 25 may be configured to rotatably bias rotor 20 in a first direction R1, or a second direction that is opposite R1, depending upon which direction handle 12 is required to rotate when release mechanism 10 is installed on a seat or other structure. For example, in FIG. 1 mechanism 10 is mounted on a left side of a seat 2, and handle 12 rotates upwardly when the handle 12 is pulled by a user. However, mechanism 10 may also be installed on a seat at a lower right side edge whereby the mechanism 10 is rotated 180 degrees about a horizontal axis relative to the orientation shown in FIG. 1. If mechanism 10 is configured for use on a right side edge of a seat, the spring 25 is configured to provide a bias in the opposite rotational direction, and cable 11 will be configured to extend out of an opposite sidewall of housing 14. Because the mechanism 10 is substantially symmetrical (other than spring 25) about a center plane “P” (FIG. 2) Cable 11 is oriented in either the configuration shown in FIG. 2 in solid lines, or in the configuration shown in dashed lines 11A as also shown in FIG. 2.

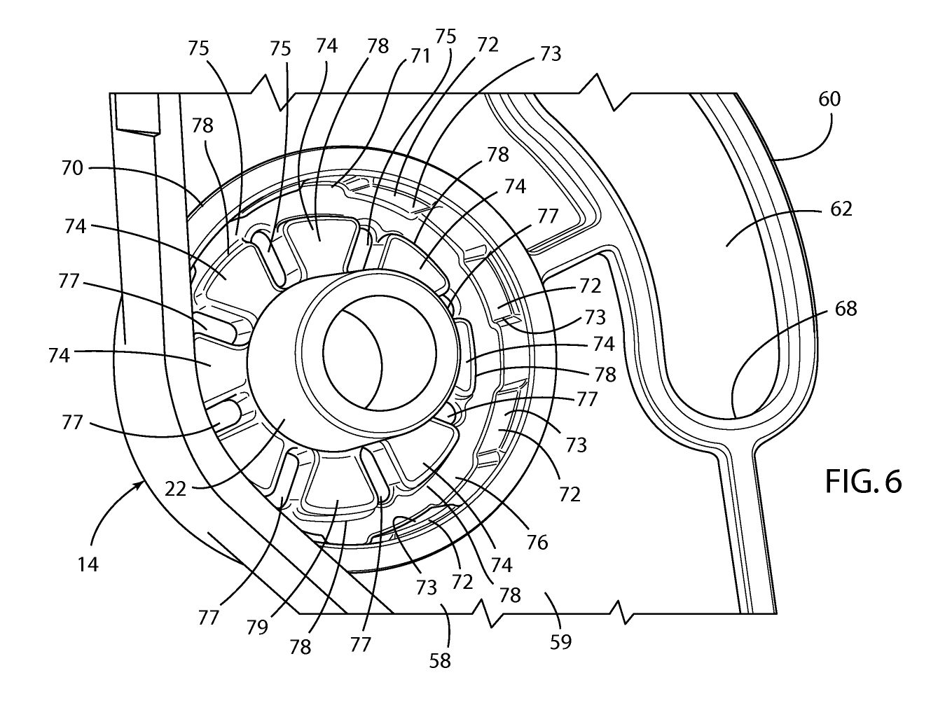

With further reference to FIG. 6, housing 14 includes an annular wall 70 protruding from inner side surface 58 of sidewall 59 of housing 14. An inner side of sidewall 70 includes a plurality of raised portions or pads 72 having cylindrical end surface portions 73. A ring-like annular space 76 is formed between boss 22 and cylindrical sidewall 70. A plurality of protrusions 74 project into annular space 76 from sidewall 59. A plurality of grooves 77 are formed between protrusions 74. Grooves 77 extend radially away from boss 22. When assembled, end 26 (see also FIG. 5) of spring 25 is received in a selected one of the grooves 77 to thereby rotationally retain the spring 25 relative to housing 14.

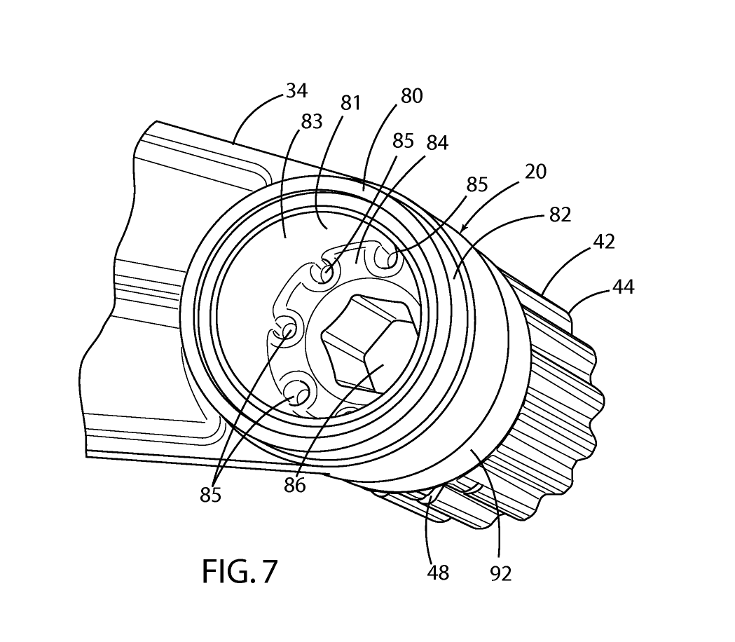

The protrusions 74 also define convex cylindrical outer surfaces 78 that face the concave cylindrical surfaces 73 of pads 72 of cylindrical sidewall 70. When assembled, the space between surfaces 73 and 78 receives end portion 80 (FIG. 7) of arm 34 of rotor 20. End portion 80 of rotor 20 includes a cylindrical inner side surface 81 that defines a cylindrical cavity or space 83. End portion 20 also includes a cylindrical outer surface 82. When mechanism 10 is assembled, end 28 (see also FIG. 4) of spring 25 is received in a selected one of a plurality of openings 85 in inner base surface 84 of cavity 83. An opening 86 in rotor 20 has a hexagonal shape to receive a hexagonal tool (not shown) during assembly of rotor 20 and housing 14 to control the rotational position of rotor 20 relative to housing 14.

During assembly, end 26 of spring 25 (FIG. 4) is positioned in a selected slot 77 (FIG. 6) of housing 14, with a portion of spring 25 being disposed between cylindrical sidewall 70 and boss 22 of housing 14. Rotor 20 is then moved to a position adjacent housing 14, such that end 28 of spring 25 is received in a selected one of the openings 85 of rotor 20. Rotor 20 is then rotated relative to housing 14 using a hexagonal tool (not shown), such that spring 25 generates a torsional bias or force between housing 14 and rotor 20. Rotor 20 is then shifted axially along axis A1 (FIG. 4) to position end portion 80 of rotor 20 on the boss 22 of housing 14. End portion 80 of rotor 20 is received in the space 76 (FIG. 6) between surfaces 73 of pads 72 and the end surfaces 78 of protrusions 74. As the rotor 20 is moved into position relative to housing 14, protrusion 64 (FIG. 5) of rotor 20 is positioned in arcuate slot 62 of housing 14. After the extension 64 is positioned in arcuate slot 62, the torsional force acting on rotor 20 by the hexagonal tool is removed, and the torsional force caused by spring 25 causes extension 64 on arm 34 of rotor 20 to move into engagement with end 66 (or end 68) of arcuate slot 62. As rotor 20 is moved into position relative to housing 14, spring 25 is compressed in addition to being rotationally deformed. This causes spring 25 to generate an axial force tending to push rotor 20 away from housing 14. However, friction between extension 64 and end 66 (or 68) of arcuate slot 62 is sufficient to prevent the axial bias from shifting rotor 20 relative to housing 14.

After the temporary subassembly of housing 14 and rotor 20 is formed. Bushings 38 are assembled with housing 14, and end fitting 32 of cable 11 is positioned in connector 30A or connector 30B of arm 34 of rotor 20. It will be understood that these operations also may be performed either before rotor 20 is installed in housing 14. Cover 16 is then snapped onto housing 14 and retained thereon by wedges 52 and openings 53

Referring back to FIG. 4., After the cover 16 and housing 14 are assembled, spring 25 shifts rotor 20 towards cover 16 slightly, such that annular bearing surface 90 of extension 42 of rotor 20 slidably engages an annular bearing surface 88 formed around opening 89 of cover 16. The engagement of bearing surfaces 88 and 90 prevents rattling of rotor 20 when installed to a seat, yet permits some variation in the sizing of the components.

When assembled, outer surface 82 (FIG. 4) of end 80 of rotor 20 slidably engages surface 73 (FIG. 6) of housing 14, and outer surface 92 of extension 42 of rotor 20 slidably engages surfaces or pads 94 (FIG. 4) of opening 90 in cover 16.

During assembly, handle 12 is positioned on extension 42 of rotor 20, and a clip or other retainer (not shown) is positioned in engagement with transverse slots 48 of extension 42 to thereby retain the handle 12.

Because the rotor 20 can be temporarily assembled with housing 14, rotor 20 does not need to be retained in position relative to housing 14 by a fixture or the like while cover 16 is installed. Thus, assembly of release mechanism 10 is simplified. Also, as discussed above, the axial bias of spring 25 ensures that the bearing surface 90 of rotor 20 remains in sliding engagement with the corresponding bearing surface 88 of cover 16. The bearing surfaces 88 and 90 may comprise low friction materials, such that very little frictional resistance is generated. This permits spring 25 to have a relatively low torsional stiffness to return handle 12 to the rest position.

It is to be understood that variations and modifications can be made on the aforementioned structure without departing from the concepts of the present invention, and further it is to be understood that such concepts are intended to be covered by the following claims unless these claims by their language expressly state otherwise.

1. A release mechanism of the type that shifts an elongated connector to selectively release an adjustment mechanism, the release mechanism comprising:
a housing defining a pivot element;
a rotor disposed within the housing and pivotably engaging the pivot element for rotation about an axis, wherein the rotor is adapted to be manually rotated by a user; and wherein the rotor includes a connecting feature that provides for connecting an end of an elongated flexible cable to the rotor such that rotation of the rotor shifts the elongated flexible cable;
a helical coil spring having a first end connected to the housing, and a second end connected to the rotor, wherein the coil spring is rotationally deformed to rotationally bias the rotor for rotation in a first direction about the axis, and wherein the coil spring is compressed and biases the rotor axially away from the housing along the axis.

2. The release mechanism of claim 1, wherein:
the rotor includes a cavity; and
the pivot element comprises a boss that is received in the cavity to rotatably interconnect the rotor and the housing.

3. The release mechanism of claim 2, wherein:
the housing includes a first spring-connecting structure, and the rotor includes a second spring-connecting structure;
the coil spring comprises a helical wire coil having a plurality of coils that are disposed around the boss, and includes a first end engaging the housing and a second end engaging the rotor and generating a rotational bias.

4. The release mechanism of claim 1, including:
an elongated flexible cable having a first end connected to the rotor such that rotation of the rotor longitudinally shifts the cable.

5. The release mechanism of claim 3, including:
a retainer engaging the rotor and retaining the rotor on the boss.

6. The release mechanism of claim 5, wherein:
the housing comprises a first sidewall and an outer sidewall extending transversely from the first sidewall to define a cavity having an open side, and wherein the retainer comprises a cover closing off at least a portion of the cavity.

7. The release mechanism of claim 6, wherein:
the cover includes an opening therethrough, and wherein the rotor includes an internal portion disposed in the cavity and an elongated extension extend from the internal portion outwardly through the opening to define an external portion.

8. The release mechanism of claim 7, wherein:
the external portion includes a handle extending in a direction that is transverse to the axis.

9. The release mechanism of claim 8, wherein:
the external portion comprises a plurality of outwardly facing teeth, and wherein the handle comprises a separate component having a plurality of inwardly extending teeth engaging the outwardly facing teeth.

10. The release mechanism of claim 7, wherein:
the housing includes a generally annular groove extending around the boss, and the rotor includes an end portion movably disposed in the groove.

11. The release mechanism of claim 7, wherein:
the housing includes a first integral connector;
the cover includes a second integral connector that engages the first integral connector and retains the cover on the housing.

12. The release mechanism of claim 1, wherein:
the housing includes a first retaining feature;
the rotor includes a second retaining feature;
the first retaining feature engages the second retaining feature such that the rotor does not shift axially out of engagement with the housing due to the bias of the coil spring.

13. The release mechanism of claim 12, wherein:
the first and second retaining features comprise first and second stop surfaces that contact each other.

14. The release mechanism of claim 13, wherein:
the rotational bias of the coil spring causes the second stop surface to be biased into contact with the first stop surface.

15. The release mechanism of claim 14, wherein:
the first stop surface comprises an end surface of an arcuate slot of the housing; and
the second stop surface comprises an extension of the rotor that is disposed in the arcuate slot.

16. A method of assembling a release mechanism of the type that shifts an elongated connector to selectively release an adjustment mechanism, the method comprising:
providing a housing defining a pivot element;
providing a rotor adapted to be at least partially disposed within the housing and to pivotably engage the pivot element for rotation about an axis, the rotor including a connecting feature that provides for connecting an end of an elongated flexible cable to the rotor such that rotation of the rotor shifts the elongated flexible cable;
providing a helical coil spring having first and second ends;
engaging the first end of the coil spring with the housing;
engaging a second end of the coil spring with the rotor;
rotating the rotor relative to the housing to deform the coil spring such that the helical coil spring rotationally biases the rotor for rotation in a first direction about the axis;
shifting the rotor relative to the housing to compress the coil spring such that the coil spring biases the rotor axially away from the housing along the axis;
engaging the rotor with the housing whereby the rotor remains stationary relative to the housing to form a temporary subsassembly that tends to remain assembled as a result of forces generated by the coil spring.

17. The method of claim 16, including:
shifting the rotor away from the housing to partially disengage the rotor from the housing whereby the coil spring tends to axially shift the rotor away from the housing; and
connecting a bearing surface to the housing;
causing the rotor to movably engage the bearing surface to prevent axial shifting of the rotor away from the housing beyond a predefined position relative to the housing.

18. The method of claim 17, wherein:
the housing includes a stop surface;
the rotor includes an engagement feature; and including:
causing the engagement feature to engage the stop surface upon rotation of the rotor in a first direction to thereby limit angular rotation of the rotor relative to the housing in the first direction; and wherein:
the rotational bias of the coil spring causes the engagement feature to frictionally engage the stop surface and to generate sufficient friction to overcome axial forces generated by the coil spring to thereby prevent axial movement of the rotor away from the housing.

19. The method of claim 18, wherein:
the housing includes an elongated arcuate slot having an end forming the stop surface;
the engagement feature comprises a protrusion; and including:
causing the protrusion to contact the stop surface.
